(19) United States
(12) Patent Application Publication
(10) Pub. No.: US 2015/0353677 A1
(43) Pub. Date: Dec. 10, 2015

(54) POLYMER PRODUCTION APPARATUS

(71) Applicants: Satoshi IZUMI, (US); Taichi NEMOTO, (US); Yoko ARAI, (US); Yasuo KAMADA, (US); Chiaki TANAKA, (US)

(72) Inventors: Satoshi IZUMI, Shizuoka (JP); Taichi NEMOTO, Shizuoka (JP); Yoko ARAI, Shizuoka (JP); Yasuo KAMADA, Shizuoka (JP); Chiaki TANAKA, Shizouka (JP)

(73) Assignee: Ricoh Company, Ltd., Ohta-ku, Tokyo (JP)

(21) Appl. No.: 14/763,538

(22) PCT Filed: Jan. 27, 2014
(86) PCT No.: PCT/JP2014/052367

§ 371 Date: Jul. 27, 2015

(30) Foreign Application Priority Data
Jan. 28, 2013 (JP) 2013-013274
Mar. 15, 2013 (JP) 2013-053616

(51) Int. Cl. C08G 63/08; B01J 19/00; B01J 19/18

(52) U.S. Cl. CPC C08G 63/08; B01J 19/18; B01J 19/0066; B01J 2219/00761

(57) ABSTRACT

To provide a polymer production apparatus, which contains: a first supply unit configured to supply raw materials including a monomer; a second supply unit configured to supply a compressive fluid; a contact unit configured to bring the monomer into contact with the compressive fluid; and a reaction unit configured to allow the monomer, which has been brought into contact with the compressive fluid, to react in the presence of the compressive fluid, wherein the reaction unit contains one, or two or more extrusion devices, and one, or two or more stirring devices.

### TECHNICAL FIELD

The present invention relates to a polymer production apparatus.

### BACKGROUND ART

Conventionally, various types of a polymer have been produced depending on use thereof, and have been industrially used. For example, a biodegradable polymer has been known as a material that is decomposed into water and carbon dioxide due to microorganism, and is incorporated in a carbon cycle of the nature. Accordingly, demands for a biodegradable polymer, such as polylactic acid, have been increased owing to high interest in the protection of the environment. As for a polymerization method of a polymer, such as a biodegradable polymer, known is a method where a monomer in a melted state is polymerized.

In the case where a monomer of a melted state is polymerized, however, there is a problem that a yield of a resulting product is low due to influence of heat. As for one of the means for solving the aforementioned problem, for example, disclosed is a production method of polyester using a polymer synthesis device described in PTL 1. In accordance with this production method, it is described that a polymer is attained at high yield by reducing an influence of thermal decomposition during depolymerization for generating a lactide monomer, which is a raw material.

### CITATION LIST

### Patent Literature

PTL 1: Japanese Application Laid-Open (JP-A) No. 2007-100011

### SUMMARY OF INVENTION

### Technical Problem

Even through an influence of a thermal decomposition during generation of a monomer of a raw material is reduced, however, there is a problem that a yield of a polymer is reduced by heat as heat is further applied during polymerization of the monomer.

### Solution to Problem

The present invention is a polymer production apparatus, which contains:

a first supply unit configured to supply raw materials including a monomer;

a second supply unit configured to supply a compressive fluid;

a contact unit configured to bring the monomer into contact with the compressive fluid; and

a reaction unit configured to allow the monomer, which has been brought into contact with the compressive fluid, to react in the presence of the compressive fluid,

wherein the reaction unit contains one, or two or more extrusion devices, and one, or two or more stirring devices.

### Advantageous Effects of Invention

The present invention attains an effect of obtaining a polymer with a high yield.

### BRIEF DESCRIPTION OF DRAWINGS

FIG. 1 is a general phase diagram depicting the state of a substance depending on pressure and temperature.

FIG. 2 is a phase diagram which defines a range of a compressive fluid in the present embodiment.

FIG. 3 is a system diagram illustrating one example of a polymerization step.

FIG. 4 is a system diagram illustrating one example of a polymerization step.

FIG. 5 is an enlarged schematic diagram of a reaction unit.

FIG. 6 is an enlarged schematic diagram of a reaction unit.

### DESCRIPTION OF EMBODIMENTS

### First Embodiment

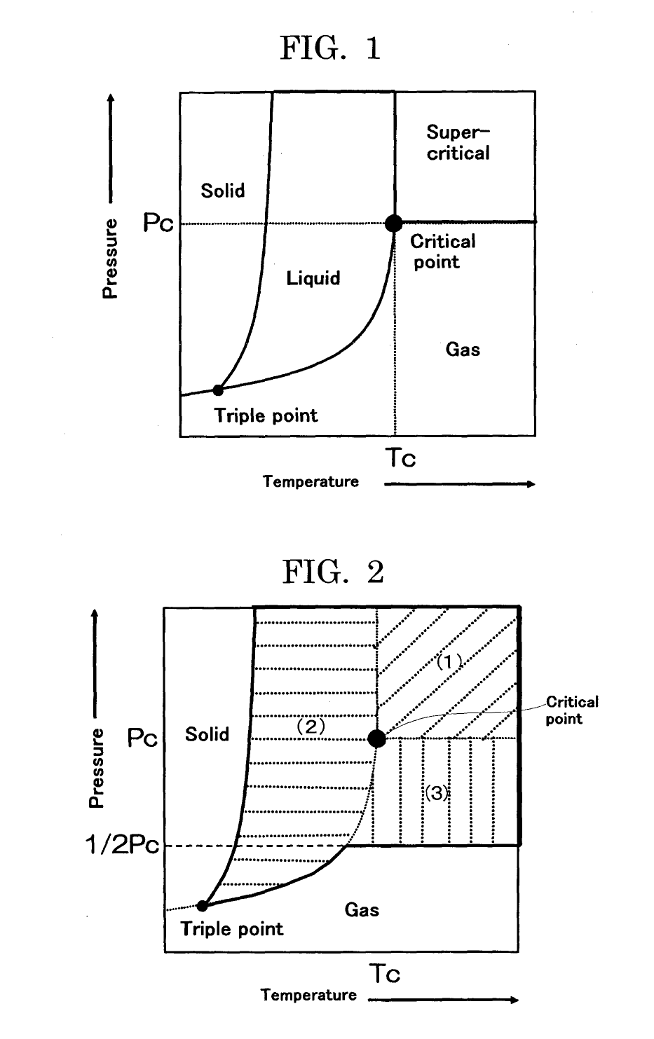

The embodiment of the present invention is explained with reference to FIGS. 1 to 6, hereinafter.

The polymer production apparatus according to one embodiment of the present invention contains a first supply unit configured to supply raw materials including a monomer, a second supply unit configured to supply a compressive fluid, a contact unit configured to bring the monomer into contact with the compressive fluid, and a reaction unit configured to allow the monomer, which has been brought into contact with the compressive fluid, to react in the presence of the compressive fluid, wherein the reaction unit contains one, or two or more extrusion devices, and one, or two or more stirring devices.

The polymer production apparatus can allow a monomer to carry out a polymerization reaction after bringing raw materials including the monomer into contact with a compressive fluid. Use of the polymer production apparatus can allow the polymerization reaction to carry out at temperature lower than conventional reaction temperature, and therefore an influence from heat to a resulting polymer can be reduced. By providing an extrusion device(s) and a stirring device(s) to the reaction unit, formation of an inhomogeneous product due to partial progression of a polymerization reaction is prevented to thereby produce a more even polymer, and clogging of the pipe with the polymer product, which is caused by accumulating the polymer product inside the pipe, can be prevented. As a result, a polymer can be obtained at high yield.

### Embodiment 1

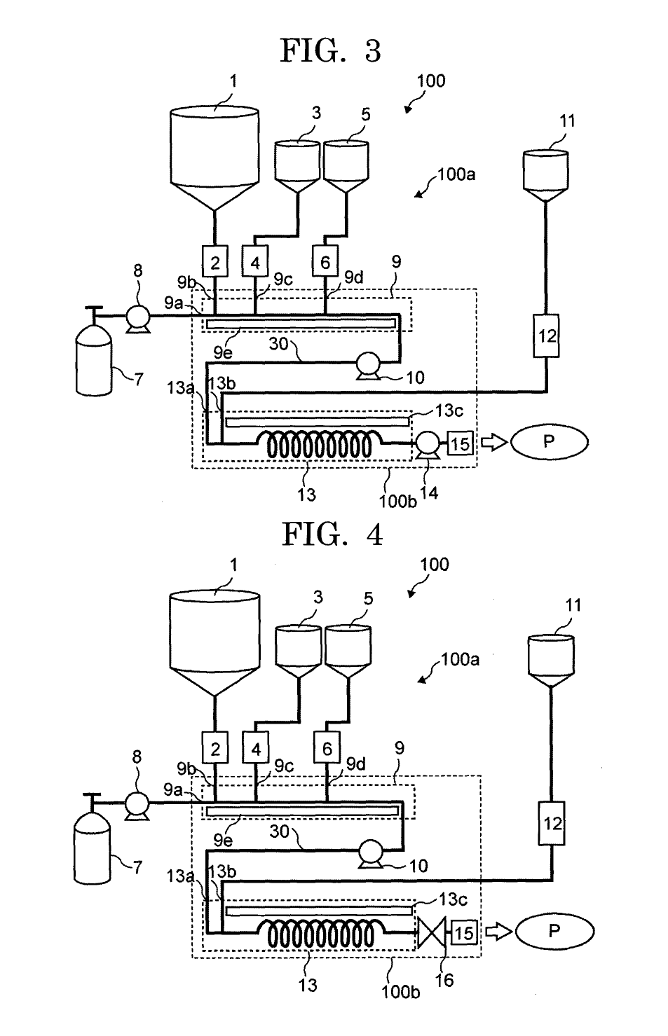

Subsequently, a polymer production apparatus suitably used for the polymer production method of the present embodiment is explained with reference to FIGS. 3 and 4. FIGS. 3 and 4 are each a system diagram illustrating one example of a polymerization step. In the system diagram of FIG. 3, the polymer production apparatus 100 contains a supply unit 100a configured to supply raw materials, such as a ring-opening polymerizable monomer as one example of a monomer, and a compressive fluid, and a polymer production apparatus main body 100b configured to polymerize the ring-opening polymerizable monomer sullied by the supply unit 100a. The supply unit 100a contains tanks (1, 3, 5, 7, 11), measuring feeders (2, 4), and measuring pumps (6, 8, 12). The polymer production apparatus main body 100b contains a contact unit 9 provided at one end of the polymer production apparatus main body 100b, a liquid feeding pump 10, a reaction unit 13, a measuring pump 14, and an extrusion cap 15 provided at the other end.

The tank 1 of the supply unit 100a stores a ring-opening polymerizable monomer. The ring-opening polymerizable monomer to be stored may be a powder or liquid. The tank 3 stores solids (powder or particles) among the materials used as an initiator and additives. The tank 5 stores liquids among the materials used as the initiator and additives. The tank 7 stores a compressive fluid. Note that, the tank 7 may store gas or a solid that is transformed into a compressive fluid upon application of heat or pressure during the process for supplying to the contact unit 9, or within the contact unit 9. In this case, the gas or solid stored in the tank 7 is transformed in the state of (1), (2), or (3) of FIG. 2 in the contact unit 9 upon application of heat or pressure. FIG. 2 is a phase diagram for defining the range of the compressive fluid in the present embodiment. The details of the compressive fluid are explained later.

The measuring feeder 2 is one example of the first supply unit configured to supply the raw materials including a monomer, and is configured to measure the ring-opening polymerizable monomer stored in the tank 1 and continuously supply the measured ring-opening polymerizable monomer to the contact unit 9. The measuring feeder 4 is configured to measure the solids stored in the tank 3 and continuously supply the measured solids to the contact unit 9. The measuring pump 6 is configured to measure the liquid stored in the tank 5 and continuously supply the measured liquid to the contact unit 9. The measuring pump 8 is one example of a second supply unit for supplying a compressive fluid (second compressive fluid), and is configured to continuously supply the compressive fluid stored in the tank 7 to the contact unit 9 at a constant flow rate under constant pressure. Note that, in the present embodiment, the phrase “continuously supply” is used as a concept in reverse to a supply per batch, and means to supply in a manner that a polymer obtained by ring-opening polymerization is continuously attained. Specifically, each material may be intermittently supplied as long as a polymer is continuously obtained. In the case where the materials used as the initiator and additives are all solids, the polymer production apparatus 100 may not contain the tank 5 and the measuring pump 6. Similarly, in the case where the materials used as the initiator and additives are all liquids, the polymerization reaction apparatus 100 may not contain the tank 3 and the measuring feeder 4.

In the present embodiment, the polymer production apparatus main body 100b is a pipe-shaped device having a monomer inlet, from which the ring-opening polymerizable monomer is introduced, at one end, and a polymer outlet, from which a polymer is discharged, at the other end. Moreover, a compressive fluid inlet from which the compressive fluid is introduced is provided at one end of the polymer production apparatus main body 100b, and a catalyst inlet from which a catalyst is introduced is provided between one end and the other end of the polymerization reaction apparatus main body 100b. The devices equipped in the polymer production apparatus 100b are connected with a pressure resistant pipe 30, through which the raw materials, compressive fluid, or generated polymer are transported, as illustrated in FIG. 3. Moreover, each of the contact unit 9, liquid feeding pump 10, and reaction unit 13 of the polymerization reaction apparatus has a pipe-shaped member through which the aforementioned raw materials or the like are transported.

The contact unit 9 of the polymer production apparatus main body 100b is composed of a pressure resistant device or pipe, which is configured to continuously bring the raw materials, such as the ring-opening polymerizable monomer, initiator, and additives, supplied from respective tanks (1, 3, 5), into contact with the compressive fluid supplied from the tank 7. In the contact unit 9, the raw materials are melted or dissolved by bringing the raw materials into contact with a compressive fluid. In the present embodiment, the term “melt” means that raw materials or a generated polymer is plasticized or liquidized with swelling as a result of the contact between the raw materials or generated polymer, and the compressive fluid. Moreover, the term “dissolve” means that the raw materials are dissolved in the compressive fluid. In the case where the ring-opening polymerizable monomer is dissolved, a flow phase is formed. In the case where the ring-opening polymerizable monomer is melted, a melt phase is formed. It is preferred that one phase of either the melt phase or the flow phase be formed for uniformly carrying out a reaction. In order to carry out the reaction in the state that a ratio of the raw materials is high relative to the compressive fluid, moreover, the ring-opening polymerizable monomer is preferably melted. Note that, in the present embodiment, the raw materials, such as the ring-opening polymerizable monomer, can be continuously brought into contact with the compressive fluid in the contact unit 9 at the constant ratio of concentration, by continuously supplying the raw materials and the compressive fluid. As a result, the raw materials can be efficiently melted, or dissolved.

The contact unit 9 may be composed of a tank-shaped device, or a tube-shaped device, but it is preferably a tube-shape device (contact vessel) from one end of which raw materials are fed, and from the other end of which a mixture, such as a melt phase, and a flow phase is taken out. Moreover, a stirring device configured to stir the raw materials and the compressive fluid may be provided to the contact unit 9. As for such device, preferred are a single screw stirring device, a twin-screw stirring device where screws are engaged with each other, a biaxial mixer containing a plurality of stirring elements which are engaged or overlapped with each other, a kneader containing spiral stirring elements which are engaged with each other, and a static mixer. Among them, the bi-axial or multi-axial stirrer stirring elements of which are engaged with each other is particularly preferable because there is a less amount of the depositions of the reaction product onto the stirrer or container, and it has self-cleaning properties. In the case where the contact unit 9 is not equipped with a stirring device, the contact unit 9 is composed of part of the pressure resistant pipe 30. Note that, in the case where the contact unit 9 is composed of the pipe 30, the ring-opening polymerizable monomer supplied to the contact unit 9 is preferably liquidized in advance, in order to surely mix all of the materials in the contact unit 9.

To the contact unit 9, an inlet 9a, which is one example of the compressive fluid inlet configured to introduce the compressive fluid supplied from the tank 7 by the measuring pump 8, an inlet 9b, which is one example of the monomer inlet configured to introduce the ring-opening polymerizable monomer sullied from the tank 1 by the measuring feeder 2, an inlet 9c configured to supply the powder supplied from the tank 3 by the measuring feeder 4, and an inlet 9d configured to introduce the liquid supplied from the tank 5 from the measuring pump 6 are provided. In the present embodiment, each inlet (9a, 9b, 9c, 9d) is composed of a pipe-shaped member, such as part of a cylinder or pipe 30 for supplying the raw materials in the contact unit 9, and a connector for connecting each pipe through which each raw material or compressive fluid is transported. The connector is not particularly limited, and selected from conventional connectors, such as reducers, couplings, Y, T, and outlets. Moreover, a heater 9e configured to heat the supplied raw materials and compressive fluid is provided to the contact unit 9.

The liquid feeding pump 10 is configured to feed a mixture formed in the contact unit 9, such as a melt phase or a fluid phase, to the reaction unit 13. The tank 11 is configured to store a catalyst. The measuring pump 12 is configured to measure the catalyst stored in the tank 11 and supply the measured catalyst to the reaction unit 13.

To reaction unit 13, a device (reaction device), which is configured to mix the melted raw materials fed by the liquid feeding pump 10 with the catalyst supplied by the measuring pump 12 to carry out ring-opening polymerization of a ring-opening polymerizable monomer, is provided. The reaction device is composed of a pressure resistant device or tube. The reaction unit 13 may be composed of a tank-shaped device, or a tube-shaped device, but the tube-shaped device is preferable as it gives less dead space. Moreover, examples of the reaction device of the reaction unit 13 include a combination of a stirring device for stirring the raw materials and the compressive fluid, and an extrusion device. As for the stirring device of the reaction unit 13, preferred is a bi- or multi-axial driven stirring device having screws engaging with each other, stirring elements of 2-flights (oval), stirring elements of 3-flights (triangle), or circular or multi-leaf shape (clover shape) stirring wings, in view of self-cleaning. In the case where the raw materials including the catalyst are sufficiently mixed in advance, a motionless mixer, which divides and compounds (recombines) the flows in multiple stages, can also be used as the stirring device. Examples of the motionless mixer include: multiflux batch mixers disclosed in Japanese examined patent application publication (JP-B) Nos. 47-15526, 47-15527, 47-15528, and 47-15533; and a Kenics-type mixer disclosed in Japanese Patent Application Laid-Open (JP-A) No. 47-33166. The descriptions of these publications are incorporated herein as a reference. Note that, a shape of the pipe is not particularly limited. In the case where a long reaction path is desired, a spiral pipe can be used to down-size the device. Moreover, a diameter of the pipe is not particularly limited, and is appropriately determined depending on the intended use. Specific examples of the extrusion device include: a pump extruder, such as a syringe pump, and a gear pump; and a special mold extruder, such as a single screw mold extruder, a multiple screw mold extruder, and a screw extruder. Among these, the gear pump, the single screw mold extruder, and the multiple screw mold extrude are particularly preferable, as they can stably extrude and give low shearing to a polymer obtained after a polymerization reaction.

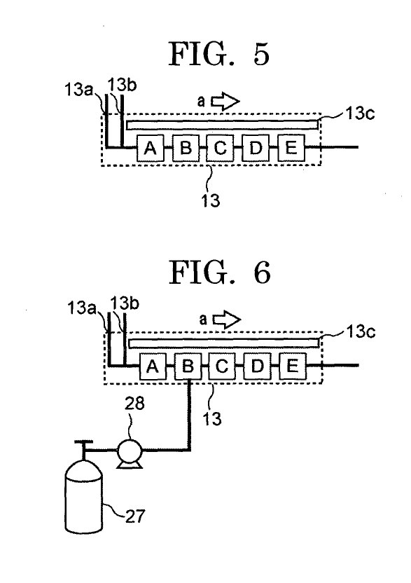

A plurality of the stirring devices and/or the extrusion devices may be provided. Applicable embodiments (Nos. 1 to 13) of the arrangement of the stirring device and the extrusion device are depicted in Table 1. In Table 1, “A” to “E” corresponds to the references depicted in FIG. 5 that is an enlarged schematic diagram of the reaction unit 13.

As for a combination of the stirring device and the extrusion device, any combination other than those depicted in Table 1 can be used as long as it does not fall outside the spirit of the present invention.

TABLE 1

| | A | B | C | D | E |
|---|---|---|---|---|---|
| No. 1 | Driven | Gear pump | | | |
| | stirring device | | | | |
| No. 2 | Driven | Twin screw | | | |
| | stirring device | extruder | | | |
| No. 3 | Driven | Single screw | | | |
| | stirring device | extruder | | | |
| No. 4 | Biaxial | Gear pump | | | |
| | stirring device | | | | |
| No. 5 | Static mixer | Single screw | | | |
| | | extruder | | | |
| No. 6 | Driven | Biaxial kneading | Gear pump | | |
| | stirring device | reaction device | | | |
| No. 7 | Driven | Tube reaction | Single screw | | |
| | stirring device | device | extruder | | |
| No. 8 | Driven | Wide-diameter tube | Gear pump | | |
| | stirring device | reaction device | | | |
| No. 9 | Wide-diameter tube | Driven | Gear pump | | |
| | reaction device | stirring device | | | |
| No. 10 | Driven | Gear pump | Static mixer | | |
| | stirring device | | | | |
| No. 11 | Static mixer | Tube reaction | Static mixer | Twin screw | |
| | | device | | extruder | |
| No. 12 | Driven | Wide-diameter tube | Twin screw | Static mixer | |
| | stirring device | reaction device | extruder | | |
| No. 13 | Driven | Biaxial kneading | Static mixer | Tube reaction | Gear pump |
| | stirring device | reaction device | | device | |

As seen from Table 1, the extrusion device may be provided upstream of the stirring device in the reaction unit, or the stirring device may be provided upstream of the extrusion device. Moreover, the extrusion devices and the stirring devices may be alternately provided.

In Table 1, the tube reaction device is a reaction device composed of a pipe, to which a stirring function and extrusion function are not particularly provided. For example, the tube reaction device may be a spiral pipe, or a linear pipe.

In the case where the motionless mixer is used as the stirring device, it is preferred that the extrusion device be provided upstream of at least one stirring device with respect to the transportation path of the polymer (the arrow “a” in FIG. 5), as the pressure loss caused by providing the motionless mixer is compensated with the extrusion device. Note that, the arrangement of the stirring device that is upstream of the extrusion device is advantageous, as the mixture is stirred before a polymerization reaction is partially progressed, to thereby further enhance evenness of a polymer.

The reaction unit 13 has an inlet 13a configured to introduce the raw materials dissolved or melted in the contact unit 9, and an inlet 13b, which is one example of the catalyst inlet configured to introduce the catalyst supplied from the tank 11 by the measuring pump 12. In the present embodiment, each inlet (13a, 13b) is composed of a pipe-shaped member, such as part of a cylinder or pipe 30 configured to pass through the raw materials in the reaction unit 13, and a connector for connecting each pipe for supplying each raw material or the compressive fluid. The connector is not particularly limited, and selected from conventional connectors, such as reducers, couplings, Y, T, and outlets. Note that, a gas outlet for removing evaporated product may be provided to the reaction unit 13. Moreover, the reaction unit 13 is equipped with a heater 13c for heating the fed raw materials.

In the first embodiment of the present invention, as illustrated in FIG. 6, the compressive fluid (second compressive fluid) is supplied to each device or pipe of the reaction unit 13, by connecting the tank 27 and the pump 28 to at least one selected from the group consisting of the stirring device, the extrusion device, and pipe of the reaction unit 13, with a pipe. FIG. 6 is an enlarged schematic diagram of the reaction unit. Note that, in FIG. 6, the compressive fluid (second compressive fluid) is supplied to the device of B, but the location to which the compressive fluid is supplied is not limited to the above, as long as the compressive fluid (second compressive fluid) is supplied to at least one location of the reaction unit 13. As for the tank 27, the one similar to the tank 7 can be used. The measuring pump 28 is one example of the third supply unit configured to supply a compressive fluid (second compressive fluid) to the reaction unit 13. As for the measuring pump 28, the one similar to the measuring pump 8 can be used. The compressive fluid (second compressive fluid) supplied to the reaction unit 13 may be identical to or different from the compressive fluid supplied by the measuring pump 8. A viscosity of a polymer can be controlled by supplying the compressive fluid (second compressive fluid) to each device or pipe of the reaction unit 13, and pressure loss can be prevented.

The example where one reaction unit 13 is provided is illustrated in FIG. 3, but the polymer production apparatus 100 may contain two or more reaction units 13. In the case where a plurality of the reaction units 13 are provided, reaction (polymerization) conditions per reaction unit 13, i.e., temperature, a concentration of the compressive fluid, a concentration of the catalyst, the pressure, the average retention time, and stirring speed, may be identical. It is however preferred that the optimal conditions be selected depending on the progress of the polymerization. Note that, it is not very good idea that excessively large number of the reaction units 13 is connected to give many stages, as it may extend a reaction time, or a device may become complicated. The number of stages is preferably 1 to 4, more preferably 1 to 3. In the case where the reaction units 13 are connected to give multiple stages, the compressive fluid or catalyst can be added after the second stage.

In the case where polymerization is performed by means of only one reaction unit, it is typically believed that a polymerization degree of an obtained polymer or an amount of monomer residues is unstable, and therefore such polymerization is not suitable for industrial production. It is considered that the instability thereof is caused because raw materials having the melt viscosity of a few poises to several tends poises and the polymerized polymer having the melt viscosity of approximately 1,000 poises are present together. On the other hand, the difference in viscosity inside the reaction unit 13 (polymerization system) can be reduced by melting the raw materials and the generated polymer in the present embodiment, and therefore a polymer can be stably produced with a reduced number of stages compared to a conventional polymerization production apparatus.

The measuring pump 14 is configured to discharge the polymer product P, which has been polymerized in the reaction unit 13, from the extrusion cap 15, to thereby send the polymer product P out of the reaction unit 13. The extrusion cap 15 is one example of the discharge unit configured to discharge the polymer obtained through the polymerization reaction in the reaction unit 13. Note that, the polymer product P may be discharged from the reaction unit 13 without using the measuring pump 14 by utilizing the pressure difference between inside and outside the reaction unit 13. In this case, the pressure control valve 16 may be used instead of the measuring pump 14, as illustrated in FIG. 4, in order to control the pressure inside the reaction unit 13, or the discharging amount of the polymer product P.

In the present embodiment, a transportation path of a monomer or generated polymer, which is from the measuring feeder 2 (first supply unit) to the extrusion cap 15 (discharge unit) is preferably communicated. As a result, a polymerization reaction can be continuously performed, to thereby prevent formation of an inhomogeneous product due to partial progression of the polymerization reaction.

### Embodiment 2

One embodiment of polymer production using the polymer production apparatus of the present invention is explained hereinafter.

### <<Raw Materials>>

First, components used as raw materials, such as a ring-opening polymerizable monomer, are explained. In the present embodiment, the raw materials are materials from which a polymer is produced, and contain materials that will be constitutional components of a polymer. The raw materials contains at least a ring-opening polymerizable monomer, and may further contain appropriately selected optional components, such as an initiator, and additives, according to the necessity.

### <Ring-Opening Polymerizable Monomer>

The ring-opening polymerizable monomer for use in the present embodiment is preferably a ring-opening polymerizable monomer containing a carbonyl skeleton, such as an ester bond, in a ring thereof, although it depends on a combination of the ring-opening polymerizable monomer for use and a compressive fluid for use. The carbonyl skeleton is formed by oxygen, which has high electronegativity, and carbon through a π-bond. As electrons of the i-bond are attracted, oxygen is negatively polarized, and carbon is positively polarized, to thereby enhance reactivity. In the case where the compressive fluid is carbon dioxide, it is assumed that affinity between carbon dioxide and a generated polymer is high, as the carbonyl skeleton is similar to the structure of carbon dioxide. As a result of these functions, a plasticizing effect of the generated polymer due to the compressive fluid is enhanced. Examples of the ring-opening polymerizable monomer include cyclic ester, and cyclic carbonate.

The cyclic ester is not particularly limited, but it is preferably a cyclic dimer obtained through dehydration-condensation of an L-form and/or D-form of a compound represented by General Formula 1.

R—C*—H(—OH)(—COOH) General Formula 1

In General Formula 1, R is a C1-C10 alkyl group, and C* represents an asymmetric carbon.

Specific examples of the compound represented by General Formula 1 include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among them, enantiomers of lactic acid are preferable since they are highly reactive and readily available. These cyclic dimers may be used independently, or as a mixture.

Examples of the cyclic ester other than the compound represented by General Formula 1 include aliphatic lactone, such as β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. Among them, ε-caprolactone is particularly preferable since it is highly reactive and readily available.

Moreover, the cyclic carbonate is not particularly limited, and examples thereof include ethylene carbonate, and propylene carbonate. These ring-opening polymerizable monomers may be used alone or in combination.

### <Catalyst>

A catalyst is suitably used in the present embodiment. The catalyst for use in the present embodiment is appropriately selected depending on the intended purpose, and the catalyst may be a metal catalyst containing a metal atom, or an organic catalyst that does not contain a metal atom.

The metal catalyst is not particularly limited. As for the metal catalyst, used are conventional metal catalysts, such as a tin compound (e.g., tin octylate, tin dibutylate, and bis(2-ethylhexanoic acid)tin salt), an aluminum compound (e.g., aluminum acetylacetonate, and aluminum acetate), a titanium compound (e.g., tetraisopropyl titanate, and tetrabutyl titanate), a zirconium compound (e.g., zirconium isopropoxide), and an antimony compound (e.g., antimony trioxide).

In the case where the intended use of a generated product obtained in the polymerization step requires safety and stability, the catalyst for use in the present embodiment is preferably an organic compound (organic catalyst) free from a metal atom. Use of the organic catalyst free from a metal catalyst as the catalyst is preferable in the present embodiment, as time required for a polymerization reaction can be shortened compared to a case where a ring-opening polymerizable monomer is polymerized through ring-opening polymerization using an organic catalyst free from a metal atom in a conventional production method, and a polymer production method having an excellent polymerization rate can be provided. In the present embodiment, the organic catalyst is not limited, as long as it contributes to a ring-opening polymerization reaction of the ring-opening polymerizable monomer, and it is detached and regenerated through a reaction with alcohol after forming an active intermediate product with the ring-opening polymerizable monomer.

The organic catalyst is preferably a compound having basicity and serving as a nucleophilic agent, more preferably a compound containing a nucleophilic nitrogen atom and having basicity, and more preferably a cyclic compound containing a nucleophilic nitrogen atom and having basicity. Note that, a nucleophilic agent (nucleophilic properties) is a chemical species (and properties thereof), which reacts with an electrophile. Such compound is not particularly limited, and examples thereof include cyclic monoamine, cyclic diamine (e.g., a cyclic diamine compound having an amidine skeleton), a cyclic triamine compound having a guanidine skeleton, a heterocyclic aromatic compound containing a nitrogen atom, N-heterocyclic carbine. Note that, a cationic organic catalyst is used for the ring-opening polymerization reaction, but the cationic organic catalyst takes hydrogen off (back-biting) from a principle chain of a polymer and therefore a molecular weight distribution of a resulting polymer product becomes wide and it is difficult to obtain the polymer product having high molecular weight.

Examples of the cyclic monoamine include quinuclidine. Examples of the cyclic diamine include 1,4-diazabicyclo[2.2.2]octane (DABCO) and 1,5-diazabicyclo(4,3,0)nonene-5. Examples of the cyclic diamine compound having a diamine skeleton include 1,8-diazabicyclo[5.4.0]undec-7-ene (DBU) and diazabicyclononene. Examples of the cyclic triamine compound having a guanidine skeleton include 1,5,7-triazabicyclo[4.4.0]dec-5-ene (TBD) and diphenylguanidine (DPG).

Examples of the heterocyclic aromatic compound containing a nitrogen atom include N,N-dimethyl-4-aminopyridine (DMAP), 4-pyrrolidinopyridine (PPY), pyrrocolin, imidazole, pyrimidine and purine. Examples of the N-heterocyclic carbine include 1,3-di-tert-butylimidazol-2-ylidene (ITBU). Among them, DABCO, DBU, DPG, TBD, DMAP, PPY, and ITBU are preferable, as they have high nucleophilicity without being greatly affected by steric hindrance, or they have such boiling points that they can be removed under the reduced pressure.

Among these organic catalysts, for example, DBU is liquid at room temperature, and has a boiling point. In the case where such organic catalyst is selected for use, the organic catalyst can be removed substantially quantitatively from the obtained polymer by treating the polymer under the reduced pressure. Note that, the type of the organic solvent, or whether or not a removal treatment is performed, is determined depending on an intended use of a generated polymer product.

A type and amount of the organic catalyst for use cannot be determined unconditionally as they vary depending on a combination of the compressive fluid and the ring-opening polymerizable monomer for use, but the amount thereof is preferably 0.01 mol % to 15 mol %, more preferably 0.1 mol % to 1 mol %, and even more preferably 0.3 mol % to 0.5 mol %, relative to 100 mol % of the ring-opening polymerizable monomer. When the amount thereof is smaller than 0.01 mol %, the catalyst is deactivated before completion of the polymerization reaction, and as a result a polymer having a target molecular weight cannot be obtained in some cases. When the amount thereof is greater than 15 mol %, it may be difficult to control the polymerization reaction.

### <Optional Components>

In the production method of the present embodiment, other than the ring-opening polymerizable monomer, a ring-opening polymerization initiator (initiator) and other additives can be used as optional components of the raw materials.

### <<Initiator>>

In the present embodiment, an initiator is suitably used for controlling a molecular weight of a polymer to be generated. As for the initiator, a conventional initiator can be used. The initiator may be, for example, aliphatic monoalcohol or dialcohol, or polyhydric alcohol, as long as it is alcohol-based, and may be either saturated or unsaturated. Specific examples of the initiator include: monoalcohol, such as methanol, ethanol, propanol, butanol, pentanol, hexanol, heptanol, nonanol, decanol, lauryl alcohol, myristyl alcohol, cetyl alcohol, and stearyl alcohol; dialcohol, such as ethylene glycol, 1,2-propanediol, 1,3-propanediol, 1,3-butanediol, 1,4-butanediol, hexanediol, nonanediol, tetramethylene glycol, and polyethylene glycol; polyhydric alcohol, such as glycerol, sorbitol, xylitol, ribitol, erythritol, and triethanol amine; methyl lactate; and ethyl lactate.

Moreover, a polymer having an alcohol residue at a terminal thereof, such as polycaprolactonediol and polytetramethylene glycol, may be used as the initiator. A use of such polymer enables to synthesize diblock copolymers or triblock compolymers.

An amount of the initiator may be appropriately adjusted depending on a molecular weight to be obtained, but it is preferably 0.05 mol % to 5 mol % relative to 100 mol % of the ring-opening polymerizable monomer. In order to prevent unevenly initiating polymerization, a monomer and the initiator are preferably sufficiently mixed before the monomer is brought into contact with a catalyst.

### <<Additives>>

Additives may be added for ring-opening polymerization according to the necessity. Examples of the additives include a surfactant, an antioxidant, a stabilizer, an anticlouding agent, a UV ray-absorber, a pigment, a colorant, inorganic particles, various fillers, a thermal stabilizer, a flame retardant, a crystal nucleating agent, an antistatic agent, a surface wet improving agent, an incineration adjuvant, a lubricant, a natural product, a releasing agent, a plasticizer, and other similar additives. If necessary, a polymerization terminator (e.g., benzoic acid, hydrochloric acid, phosphoric acid, metaphosphoric acid, acetic acid and lactic acid) may be used after completion of a polymerization reaction. A blending amount of the additives may differ depending on a type of the additive, or a purpose for adding the additive, but it is preferably 0 parts by mass to 5 parts by mass relative to 100 parts by mass of the polymer composition.

As for the surfactant, preferably used is a surfactant, which is dissolved in the compressive fluid, and has compatibility to both the compressive fluid and the ring-opening polymerizable monomer. Use of such surfactant can give effects that the polymerization reaction can be uniformly preceded, and the resultant polymer has a narrow molecular weight distribution and be easily produced as particles. When the surfactant is used, the surfactant may be added to the compressive fluid, or may be added to the ring-opening polymerizable monomer. In the case where carbon dioxide is used as the compressive fluid, for example, a surfactant having groups having affinity with carbon dioxide and groups having affinity with the monomer can be used. Examples of such surfactant include a fluorosurfactant, and a silicone surfactant.

Examples of the stabilized include epoxidized soybean oil, and carbodiimide. Examples of the antioxidant include 2,6-di-t-butyl-4-methyl phenol, and butylhydroxyanisol. Examples of the anticlouding agent include glycerin fatty acid ester, and monostearyl citrate. Examples of the filler include clay, talc, and silica, which have effects as a UV-ray absorbing agent, a thermal stabilizer, a flame retardant, an internal mold release agent, and a crystal nucleus agent. Examples of the pigment include titanium oxide, carbon black, and ultramarine blue.

### <<Compressive Fluid>>

Next, a compressive fluid for use in the production of the present invention is explained with reference to FIGS. 1 and 2. FIG. 1 is a phase diagram depicting a state of a substance depending on temperature and pressure. FIG. 2 is a phase diagram, which defines a range of the compressive fluid, in the present embodiment. The “compressive fluid” in the present embodiment is a fluid, which is in a state that is in any of the regions (1), (2), and (3) of FIG. 2 in the phase diagram of FIG. 1.

In such regions, the substance is known to have extremely high density and show different behaviors from those shown at normal temperature and normal pressure. Note that, a substance is a supercritical fluid when it is in the region (1). The supercritical fluid is a fluid that exists as a noncondensable high-density fluid at temperature and pressure exceeding the limiting points (critical points) at which a gas and a liquid can coexist. When a substance is in the region (2), the substance is a liquid, but in the present embodiment, it is a liquefied gas obtained by compressing a substance existing as a gas at normal temperature (25° C.) and ambient pressure (1 atm). When a substance is in the region (3), the substance is in the state of a gas, but in the present invention, it is a high-pressure gas whose pressure is ½ or higher than the critical pressure (Pc), i.e. ½ Pc or higher.

Examples of a substance that can be used in a state of the compressive fluid include carbon monoxide, carbon dioxide, dinitrogen oxide, nitrogen, methane, ethane, propane, 2,3-dimethylbutane, and ethylene. Among them, carbon dioxide is preferable because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used alone, or in combination.

In the case where supercritical carbon dioxide is used as a solvent, it has been conventionally considered that carbon dioxide is not suitable for living anionic polymerization, as it may react with basic and nucleophilic substances. However, the present inventors have found that, overturning the conventional insight, a polymerization reaction progresses quantitatively for a short period, by stably coordinating a basic and nucleophilic organic catalyst with a ring-opening monomer even in supercritical carbon dioxide, to thereby open the ring structure thereof, and as a result, the polymerization reaction progresses livingly. In the present specification, the term “living” means that the reaction progresses quantitatively without a side reaction such as a transfer reaction or termination reaction, so that a molecular weight distribution of an obtained polymer is relatively narrow, and is monodispersible.

### <<Polymerization Method>>

Subsequently, a polymerization method of the ring-opening polymerizable monomer using the polymer production apparatus 100 is explained. In the present embodiment, the ring-opening polymerizable monomer and the compressive fluid are continuously supplied and brought into contact with each other to polymerize the ring-opening polymerizable monomer through ring-opening polymerization to thereby continuously obtain a polymer. First, each of the measuring feeders (2, 4), the measuring pump 6, and the measuring pump 8 are operated to continuously supply the ring-opening polymerizable monomer, the initiator, the additives, and the compressive fluid from the respective tanks (1, 3, 5, 7). As a result, the raw materials and the compressive fluid are continuously supplied into the pipe of the contact unit 9 from the respective inlets (9a, 9b, 9c, 9d). Note that, solid (powder or granular) raw materials may have lower measuring accuracy compared to liquid raw materials. In this case, the solid raw materials may be turned into liquid and stored in the tank 5, and then is introduced into the pipe of the contact unit 9 by the measuring pump 6. The order for operating the measuring feeders (2, 4), measuring pump 6, and measuring pump 8 is not particularly limited. However, it is preferred that the measuring pump 8 be operated first, as the raw materials may be solidified due to reduction in temperature, if the initial raw materials are sent to the reaction unit 13 without being in contact with the compressive fluid.

The feeding speed of each raw material by the each of measuring feeders (2, 4) and the measuring pump 6 is adjusted based on the predetermined quantity ratio of the ring-opening polymerizable monomer, initiator, and additives to give a constant ratio. A total mass of raw materials supplied per unit time (feeding speed of the raw materials (g/min)) by the measuring feeders (2, 4) and measuring pump 6 is adjusted based on the desired properties of the polymer or reaction time. Similarly, a mass of the compressive fluid supplied per unit time (feeding speed of the compressive fluid (g/min)) by the measuring pump 8 is adjusted based on the desired properties of the polymer or reaction time. A ratio (the feeding speed of the raw material/the feeding speed of the compressive fluid, which is also referred to as a feeding ratio) of the feeding speed of the raw materials to the feeding speed of the compressive fluid is preferably 1 or greater, more preferably 3 or greater, even more preferably 5 or greater, and particularly preferably 10 or greater. Moreover, the upper limit of the feeding ratio is preferably 1,000 or less, more preferably 100 or less, and particularly preferably 50 or less.

By setting the feeding ratio to 1 or greater, a reaction progresses with the high concentration of the raw materials and a polymer product (i.e., high solid content) when the raw materials and the compressive fluid are sent to the reaction unit 13. The solid content in the polymerization system here is largely different from a solid content in a polymerization system where polymerization is performed by dissolving a small amount of a ring-opening polymerizable monomer in a significantly large amount of a compressive fluid in accordance with a conventional production method. The production method of the present embodiment is characterized by that a polymerization reaction progresses efficiently and stably in a polymerization system having a high solid content. Note that, in the present embodiment, the feeding ratio may be less than 1. In this case, there is no problem with a quality of a resulting polymer product, but economical efficiency is low. When the feeding ratio is greater than 1,000, moreover, there is a possibility that the compressive fluid may not sufficiently dissolve the ring-opening polymerizable monomer therein, and the intended reaction may not be uniformly carried out.

Since each of the raw materials and the compressive fluid are continuously introduced in the pipe of the contact unit 9, they are each continuously brought into contact with each other. As a result, the raw materials, such as the ring-opening polymerizable monomer, initiator, and additives, are dissolved or melted in the contact unit 9. In the case where the contact unit 9 is equipped with a stirring device, the raw materials and the compressive fluid may be stirred. In order to prevent the introduced compressive fluid from turning into gas, the internal temperature and pressure of the pipe of the reaction unit 13 are controlled to the temperature and pressure both equal to or higher than at least a triple point of the compressive fluid. The control of the temperature and pressure here is performed by adjusting the output of the heater 9e of the contact unit 9, or adjusting the feeding rate of the compressive fluid. In the present embodiment, the temperature for melting the ring-opening polymerizable monomer may be the temperature equal to or lower than the melting point of the ring-opening polymerizable monomer under atmospheric pressure. It is assumed that the internal pressure of the contact unit 9 becomes high under the influence of the compressive fluid so that the melting point of the ring-opening polymerizable monomer becomes lower than the melting point thereof under the atmospheric pressure. Accordingly, the ring-opening polymerizable monomer is melted in the contact unit 9, even when an amount of the compressive fluid is small with respect to the ring-opening polymerizable monomer.

In order to melt each of the raw materials efficiently, the timing for applying heat to or stirring the raw materials and compressive fluid in the contact unit 9 may be adjusted. In this case, heating or stirring may be performed after bringing the raw materials and compressive fluid into contact with each other, or heating or stirring may be performed while bringing the raw materials and compressive fluid into contact with each other. To make melting of the materials even more certain, for example, the ring-opening polymerizable monomer and the compressive fluid may be brought into contact with each other after heating the ring-opening polymerizable monomer at the temperature equal to or higher than the melting point thereof. In the case where the contact unit 9 is a biaxial mixing device, for example, each of the aforementioned aspects may be realized by appropriately setting an alignment of screws, arrangement of inlets (9a, 9b, 9c, 9d), and temperature of the heater 9e.

In the present embodiment, the additives are supplied to the contact unit 9 separately from the ring-opening polymerizable monomer, but the additives may be supplied together with ring-opening polymerizable monomer. Alternatively, the additives may be supplied after completion of a polymerization reaction. In this case, after taking the obtained polymer product from the reaction unit 13, the additive may be added to the polymer product white kneading the mixture thereof.

The raw materials melted or dissolved in the contact unit 9 are each sent by the feeding pump 10, and supplied into the reaction unit 13 from the inlet 13a. Meanwhile, the catalyst in the tank 11 is measured by the metering pump 12, and the predetermined amount thereof is supplied to the reaction unit 13 through the inlet 13b. The catalyst can function even at room temperature, and therefore, in the present embodiment, the catalyst is added after melting the raw materials in the compressive fluid. In the conventional art, the timing for adding the catalyst has not been discussed in the ring-opening polymerization of the ring-opening polymerizable monomer using the compressive fluid. In the present embodiment, in the course of the ring-opening polymerization, the catalyst (especially, the organic catalyst) is added to the polymerization system in the reaction unit 13, in which the mixture of the raw materials, such as the ring-opening polymerizable monomer, and initiator, are sufficiently dissolved or melted in the compressive fluid, because of the high activity of the catalyst. When the catalyst is added to the mixture in the state where the mixture is not sufficiently dissolved or melted, a reaction may unevenly progresses.

The raw materials sent by the liquid feeding pump 10 and the catalyst supplied by the measuring pump 12 are optionally sufficiently stirred in the stirring device of the reaction unit 13, or heated to the predetermined temperature by the heater 13c when transported. As a result, ring-opening polymerization reaction of the ring-opening polymerizable monomer is carried out in the reaction unit 13 in the presence of the catalyst (polymerization step).

The lower limit of the temperature (polymerization reaction temperature) for ring-opening polymerization of the ring-opening polymerizable monomer is not particularly limited, but it is 40° C., preferably 50° C., more preferably 60° C. When the polymerization reaction temperature is lower than 40° C., it may be take a long time to melt the ring-opening polymerizable monomer with the compressive fluid depending on a type of the ring-opening polymerizable monomer for use, melting may be insufficient, or an activity of the catalyst may be low. As a result, the reaction speed may be reduced during the polymerization, and therefore it may not be able to proceed to the polymerization reaction quantitatively.

The upper limit of the polymerization reaction temperature is not particularly limited, but the upper limit thereof is 150° C., or the temperature higher than the melting point of the ring-opening polymerizable monomer by 50° C., whichever higher. The upper limit of the polymerization reaction temperature is preferably 100° C., or temperature that is higher than the melting point of the ring-opening polymerizable monomer by 30° C., whichever higher. The upper limit of the polymerization reaction temperature is more preferably 90° C., or the melting point of the ring-opening polymerizable monomer, whichever higher. The upper limit of the polymerization reaction temperature is even more preferably 80° C., or temperature that is lower than the melting point of the ring-opening polymerizable monomer by 20° C., whichever higher. When the polymerization reaction temperature exceeds the temperature higher than the melting point of the ring-opening polymerizable monomer by 30° C., a depolymerization reaction, which is a reverse reaction of ring-opening polymerization, tends to be caused equilibrately, and therefore the polymerization reaction is difficult to proceed quantitatively. In the case where a ring-opening polymerizable monomer having low melting point, such as a ring opening polymerizable monomer that is liquid at room temperature, is used, the polymerization reaction temperature may be temperature that is higher than the melting point by 30° C. or greater to enhance the activity of the catalyst. Even in this case, the polymerization reaction temperature is preferably 100° C. or lower. Note that, the polymerization reaction temperature is controlled by a heater 13c equipped with the reaction unit 13, or by externally heating the reaction unit 13. When the polymerization reaction temperature is measured, a polymer product obtained by the polymerization reaction may be used for the measurement.

In a conventional production method of a polymer using supercritical carbon dioxide, polymerization of a ring-opening polymerizable monomer is carried out using a large amount of supercritical carbon dioxide, as supercritical carbon dioxide has low ability of dissolving a polymer. In accordance with the polymerization method of the present embodiment, ring-opening polymerization of a ring-opening polymerizable monomer is performed with a high concentration, which has not been realized in a conventional method for producing a polymer using a compressive fluid. In this case, the internal pressure of the reaction unit 13 becomes high in the presence of the compressive fluid, and thus glass transition temperature (Tg) of the generated polymer becomes low. As a result, the generated polymer has low viscosity, and therefore a ring-opening reaction uniformly progresses even in the state where the concentration of the polymer product is high.

In the present embodiment, the polymerization reaction time (the average retention time in the reaction unit 13) is appropriately set depending on a target molecular weight of a polymer product to be produced, but it is typically preferably within 1 hour, more preferably within 45 minutes, and even more preferably within 30 minutes. In accordance with the production method of the present embodiment, the polymerization reaction time can be made within 20 minutes. This polymerization reaction time is short, which has not been realized before in polymerization of a ring-opening polymerizable monomer in a compressive fluid.

The pressure for the polymerization, i.e., the pressure of the compressive fluid, may be the pressure at which the compressive fluid supplied by the tank 7 becomes a liquid gas ((2) in the phase diagram of FIG. 2), or high pressure gas ((3) in the phase diagram of FIG. 2), but it is preferably the pressure at which the compressive fluid becomes a supercritical fluid ((1) in the phase diagram of FIG. 2). By making the compressive fluid into the state of a supercritical fluid, melting of the ring-opening polymerizable monomer is accelerated to uniformly and quantitatively progress a polymerization reaction. In the case where carbon dioxide is used as the compressive fluid, the pressure is 3.7 MPa or higher, preferably 5 MPa or higher, more preferably 7.4 MPa or higher, which is the critical pressure or higher, in view of efficiency of a reaction and polymerization rate. In the case where carbon dioxide is used as the compressive fluid, moreover, the temperature thereof is preferably 25° C. or higher from the same reasons.

The moisture content in the reaction unit 13 is preferably 4 mol % or less, more preferably 1 mol % or less, and even more preferably 0.5 mol % or less, relative to 100 mol % of the ring-opening polymerizable monomer. When the moisture content is greater than 4 mol %, it may be difficult to control a molecular weight of a resulting product as the moisture itself acts as an initiator. In order to control the moisture content in the polymerization system, an operation for removing moistures contained in the ring-opening polymerizable monomer and other raw materials may be optionally provided as a pretreatment.

The polymer product P obtained after the ring-opening polymerization reaction in the reaction unit 13 is discharged outside the reaction unit 13 by the measuring pump 14. The speed for discharging the polymer product P by the measuring pump 14 is preferably constant to attain a uniform polymer product. To this end, the internal pressure of the polymerization system filled with the compressive fluid is kept constant and the operation is performed. In order to maintain the back pressure of the measuring pump 14 constant, the feeding speeds of a feeding system inside the reaction unit 13 and that of the liquid feeding pump 10 are controlled. In order to maintain the back pressure of the liquid feeding pump 10 constant, similarly, a feeding system and measuring feeder (2, 4) inside the contact unit 9 and the feeding speed of the measuring pump (6, 8) are controlled. The control system may be an ON-OFF control system, i.e., an intermittent feeding system, but it is in most cases preferably a continuous or stepwise control system where the rational speed of the pump or the like is gradually increased or decreased. Any of these controls realizes to stably provide a homogeneous polymer product.

The catalyst remained in the polymer product obtained in the present embodiment is removed according to the necessity. A method for removing the catalyst is not particularly limited, and examples thereof include: a vacuum distillation method in the case where the catalyst is a compound having a boiling point; a method, in which the catalyst is extracted using a compound, which dissolves the catalyst, as an entrainer; and a method, in which the catalyst is removed by absorbing the catalyst with a column. In this case, a system for removing the catalyst may be a batch system where the catalyst is removed after taking the polymer product out from the reaction unit 13, or a continuous system where the catalyst is removed successively without taking the polymer product out. In case of vacuum distillation, the vacuum conditions are set based upon the boiling point of the catalyst. For example, the temperature at the time of vacuuming is 100° C. to 120° C., and therefore the catalyst can be removed at temperature lower than temperature at which the polymer product is reacted through depolymerization. In the case where an organic solvent is used during the extraction process, it may be necessary to provide a step for removing the organic solvent after extracting the catalyst. Therefore, the compressive fluid is preferably used as a solvent also in the extraction process. As for such extraction process, a conventional technique, such as extraction of perfume, can be applied.

### <<Polymer Product>>

The polymer product of the present embodiment is a polymer product obtained in the aforementioned production method, is substantially free from an organic solvent and a metal atom, has a ring-opening polymerizable monomer residue amount of less than 2 mol %, and has a number average molecular weight of 12,000 or greater. In accordance with the production method of the present embodiment, a polymerization reaction can be performed at low temperature, as described above. Therefore, a depolymerization reaction is significantly inhibited compared to conventional melt polymerization. As a result, the polymerization rate can achieve 96 mol % or greater, preferably 98 mol % or greater. When the polymerization rate is less than 96 mol %, thermal properties as the polymer product become insufficient, and therefore it may be necessary to separately provide a process for removing the ring-opening polymerizable monomer. Note that, in the present embodiment, the polymerization rate is a ratio of the ring-opening polymerization monomer contributed to generation of a polymer, relative to the ring-opening polymerizable monomer as a raw material. An amount of the ring-opening polymerizable monomer contributed to generation of polymer can be determined by subtracting an amount of the unreacted ring-opening polymerizable monomer (an amount of the ring-opening polymerizable monomer residues) from the amount of the generated polymer.

The number average molecular weight of the polymer product obtained in the present embodiment can be adjusted by an amount of the initiator. The number average molecular weight thereof is not particularly limited, but it is typically 12,000 to 200,000. When the number average molecular weight is greater than 200,000, productivity is low because of the increased viscosity, which is not economically advantageous. When the number average molecular weight is smaller than 12,000, it may not be preferable because a resulting polymer may have insufficient strength to function as a polymer. A value obtained by dividing the weight average molecular weight Mw of the polymer product obtained in the present embodiment by the number average molecular weight Mn thereof is preferably 1.0 to 2.5, more preferably 1.0 to 2.0. When the value there is greater than 2.0, it is not preferable because it is highly possible that a polymerization reaction has been performed unevenly, so that it is difficult to control properties of the polymer.

The polymer product obtained in the present embodiment is produced by the production method that does not use a metal catalyst and an organic solvent. Therefore, the polymer product is substantially free from a metal atom and an organic solvent, and has an extremely small amount of the ring-opening polymerizable monomer residues, which is less than 4 mol % (polymerization rate: 96 mol % or greater), preferably less than 2 mol % (polymerization rate: 98 mol % or greater), and more preferably 1,000 ppm or less, and thus the polymer product has excellent safety and stability. Accordingly, the polymer product of the present embodiments is widely used in various uses, such as commodities, medical products, cosmetic products, and electrophotographic toner. Note that, in the present embodiment, the metal catalyst is a catalyst, which is used for ring-opening polymerization, and contains metal. Moreover, the “substantially free from a metal atom” means that the polymer product does not contain a metal atom originated from the metal catalyst. Specifically, the polymer product is determined that it does not contain a metal atom originated from the metal catalyst, when an amount of the metal atom originated from the metal catalyst in the polymer product is a detection liquid or lower as measured by a conventional analysis method, such as ICP-AES, atomic absorption spectrophotometry, and colorimetry. The metal catalyst is not particularly limited, and examples thereof include conventional metal catalysts, such as a tin compound (e.g., tin octylate, tin dibutylate, and bis(2-ethylhexanoic acid)tin salt), an aluminum compound (e.g., aluminum acetylacetonate, and aluminum acetate), a titanium compound (e.g., tetraisopropyl titanate, and tetrabutyl titanate), a zirconium compound (e.g., zirconium isopropoxide), and an antimony compound (e.g., antimony trioxide). Examples of the metal catalyst originated from the metal catalyst include tin, aluminum, titanium, zirconium, and antimony. In the present embodiment, moreover, the organic solvent is an organic solvent, which is use for ring-opening polymerization, and dissolves a polymer obtained by a ring-opening polymerization reaction. In the case where the polymer product obtained by the ring-opening polymerization reaction is polylactic acid (L-form 100%), examples of the organic solvent include a halogen solvent (e.g., chloroform, and methylene chloride) and tetrahydrofuran. The phrase “substantially free from an organic solvent” means an amount of the organic solvent in the polymer product measured by the following measuring method is a detection limit or lower.

### <<Measuring Method of Residual Organic Solvent>>

To 1 part by mass of the polymer product that is a subject of a measurement, 2 parts by mass of 2-propanol is added, and the resulting mixture is dispersed for 30 minutes by applying ultrasonic waves, followed by storing the resultant over 1 day or longer in a refrigerator (5° C.) to thereby extract the organic solvent in the polymer product. A supernatant liquid thus obtained is analyzed by gas chromatography (GC-14A, SHIMADZU CORPORATION) to determine quantities of the organic solvent and monomer residues in the polymer product, to thereby measure a concentration of the organic solvent. The measuring conditions for the analysis are as follows.

### Device: SHIMADZU GC-14A

### Column: CBP20-M 50-0.25

### Detector: FID

Injection amount: 1 μL to 5 μL
Carrier gas: He, 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Temperature of column: 40° C.
Injection temperature: 150° C.

### <<Use of Polymer Product>>

The polymer product obtained in the production method of the present embodiment is produced by the production method that does not use a metal catalyst and an organic solvent, and has less monomer residues. Therefore the polymer product has excellent safety and stability. Accordingly, the polymer product obtained in the production method of the present embodiment can be widely applied for various uses, such as electrophotographic developer, a printing ink, a coating for buildings, a cosmetic product, and a medical material. Various additives may be used for the polymer product in order to improve moldability, fabrication quality, degradability, tensile strength, heat resistance, storage stability, crystallinity, and weather fastness.

### Effects of Present Embodiment

In accordance with the polymer production apparatus of the present embodiment, a monomer is reacted through a polymerization reaction after bringing raw materials including the monomer into contact with a compressive fluid. In this manner, the polymerization reaction can be progressed at temperature lower than conventional reaction temperature, and therefore an influence of heat can be reduced. Moreover, formation of an inhomogeneous product due to partial progress of a polymerization reaction can be prevented to thereby form a more even polymer, and also clogging of a pipe caused by accumulation of the polymer product can be prevented. As a result, a polymer can be attained at high yield.

### EXAMPLES

The present embodiment is more specifically explained through Examples and Reference Examples hereinafter, but Examples shall not be construed as to limit the scope of the present invention. Note that, in Examples and Reference Examples, a molecular weight of the polymer obtained, a polymerization rate of a monomer, continuous productivity, and yellow index were measured in the following manner.

### <Measurement of Molecular Weight of Polymer>

A molecular weight of a polymer was measured by gel permeation chromatography (GPC) under the following conditions.

Apparatus: GPC-8020 (product of TOSOH CORPORATION)
Column: TSK G2000HXL and G4000HXL (product of TOSOH CORPORATION)

### Temperature: 40° C.

### Solvent: Tetrahydrofuran (THF)

Flow rate: 1.0 mL/min

A polymer (1 mL) having a concentration of 0.5% by mass was injected, and measured under the above-described conditions, to thereby obtain a molecular weight distribution of the polymer.

Using a molecular weight calibration curve prepared from a monodisperse polystyrene standard sample, a number average molecular weight Mn of the polymer and a weight average molecular weight Mw of the polymer were calculated from the obtained molecular weight distribution. The molecular weight distribution is a value calculated by dividing Mw with Mn. Moreover, the polymerization rate was calculated from an area ratio between the low molecule peak and the high molecule peak.

### <Continuous Productivity>

After performing a continuous operation of the apparatus illustrated in FIG. 1, the extruder was dismantled to visually evaluate whether or not gelation products or the like were deposited on the screw, single pipe, or gear part. As a result of the visual evaluation, the case where there was no deposition of the gelation product after 24 hours continuous operation was determined as “A,” the case where there was not deposition of the gelation product after 12 hours continuous operation, but there was depositions of the gelation products after 24 hours continuous operation was determined as “B,” and the case where there was depositions of the gelation product after 12 hours continuous operation was determined as “C.”

### <Yellow Index (YI Value)>

The obtained polymer product was formed into a resin pellet having a thickness of 2 mm, and a YI value thereof was measured by means of an SM color computer (manufactured by Suga Test Instruments Co., Ltd.) in accordance with JIS-K7103. The YI value of 2.0 or greater was judged as “A,” the YI value of more than 2.0 but less than 5.0 was judged as “B,” and the YI value of 5.0 or more was judged as “C.”

### Example 1

Ring-opening polymerization of L-lactide was obtained using the polymer production apparatus of FIG. 1. The structure of polymer production apparatus is described below.

### Tank 1, Metering Feeder 2:

Plunger pump NP-S462, manufactured by Nihon Seimitsu Kagaku Co., Ltd.

The tank 1 was charged with L-lactide (manufacturer: Purac, melting point: 100° C.) in the melted state, as a ring-opening polymerizable monomer.

### Tank 3, Metering Feeder 4:

Intelligent HPLC pump (PU-2080), manufactured by JASCO Corporation

The tank 3 was charged with lauryl alcohol as an initiator.

Tank 5, Metering Pump 6: Not used in Example 1
Tank 7: Carbonic acid gas cylinder

### Tank 11, Metering Pump 12:

Intelligent HPLC pump (PU-2080), manufactured by JASCO Corporation

The tank 11 was charged with 1,8-diazabicyclo[5.4.0]undec-7-ene (DBU, manufacturer: Tokyo Chemical Industry Co., Ltd.)(organic catalyst).

Device A: mixer/tank stirring device (driven stirring device)
Inner diameter of the tank: 100 mm
Length of the tank: 200 mm
Temperature of the tank: 100° C.
Rotational speed: 30 rpm
   Device B: extruder/gear pump
Set temperature of the gear pump: 100° C.
Ejecting amount: 50 cc/rev
Rotational speed: adjusted so that the pressure of the pump inlet to be 15 MPa
   Device C to Device E: Not used in Example 1.

The driven stirring device (Device A of FIG. 5) and the gear pump (Device B of FIG. 5) were operated under the aforementioned set conditions. The measuring feeder 2 supplied the melted lactide in the tank 1 to a vessel of the driven stirring device at a constant rate. The measuring feeder 4 supplied lauryl alcohol in the tank 3 at a constant rate to the vessel of the driven stirring device in an amount of 0.5 mol, relative to 99.5 mol of the supplied amount of the lactide. The measuring pump 8 supplied carbonic acid gas (carbon dioxide) as a compressive fluid from the tank 7 so that the pressure inside the vessel of the driven stirring device was to be 15 MPa. The measuring pump 12 supplied an organic catalyst (DBU) in the tank 11 at a constant rate to the vessel of the driven stirring device in an amount of 0.1 mol relative to 99.9 mol of the lactide. As a result, the driven stirring device continuously brought the raw materials, such as the lactide and lauryl alcohol supplied from the tanks, into contact with the compressive fluid and DBU to melt the raw materials, and mixed the raw materials with a stirring wing to thereby polymerize the lactide through ring-opening polymerization. Next, the polymer (polylactic acid in Example 1) obtained by the polymerization performed in the driven stirring device was sent to the gear pump. At the edge of the gear pump, a discharge outlet was provided. The gear pump stably discharged the polymer, which had high viscosity compared to the raw materials, from the outlet. In this case, the average retaining time of each raw material from the driven stirring device to discharge was set to about 1,200 seconds. The properties (Mn, Mw/Mn, polymerization rate) of the obtained polymer product were measured by the aforementioned methods, and the continuous productivity was evaluated. The results are presented in Table 3.

### Examples 2 to 13, Reference Examples 1 to 3

Polymer products of Examples 2 to 13 were obtained in the same manner as in Example 1, provided that a combination of the stirring device and the extrusion device provided to the reaction unit 13 was changed to Nos. 2 to 13, respectively, as depicted in Table 1. Polymer products of Reference Examples 1 to 3 were obtained in the same manner as in Example 1, provided that the structure of the reaction unit 13 was changed respectively, as depicted in Table 2 below. Note that, A to E in Table 1 correspond A to E of FIG. 5, respectively. The specific structures of the devices of Tables 1 and 2 are described.

Driven stirring device: Identical to the device used in Example 1
Gear pump: Identical to the device used in Example 1
Twin Screw Extruder: Screws engaged to each other

Cylinder diameter: 30 mm

Identical biaxial rotational directions

Rotational speed: 100 rpm

### Single Screw Extruder:

Cylinder diameter: 30 mm

Rotational speed: 100 rpm

Biaxial Stirring Device: Screws engaged to each other

Cylinder diameter: 30 mm

Identical biaxial rotational directions

Rotational speed: 30 rpm

### Static Mixer:

Number of elements: 12

Biaxial Kneading Reaction Device: Screws engaged to each other

Cylinder diameter: 30 mm

Opposed biaxial rotational directions

Rotational speed: 60 rpm

### Tube Reaction Device:

Inner diameter: 14.3 mm

### Wide-Diameter Tube Reaction Device:

Inner diameter: 32.9 mm

TABLE 2

| | | | | |
|---|---|---|---|---|
| A | B | C | D | E |

| | | |
|---|---|---|
| Ref. Ex. 1 | Twin screw | |
| | extruder | |
| Ref. Ex. 2 | Static mixer | |
| Ref. Ex. 3 | Driven | Wide-diameter tube |
| | stirring device | reaction device |

Properties of each of the polymer products obtained in Examples 1 to 13, and Reference Examples 1 to 3 were measured in the aforementioned methods. The results are presented in Tables 3 and 4.

In Reference Example 1, the viscosity of the raw material mixture was low, as the raw materials supplied by the supply unit were not sufficiently mixed, and therefore a back flow was caused by the twin screw extruder and a polymer could not be produced.

In Reference Examples 2 and 3, pressure loss was large and therefore the reaction pressure and the retention time could not be controlled, to thereby leave unreacted monomers (ring-opening polymerizable monomer residues).

Comparing Examples 1 to 13 with Reference Examples 1 to 3, it was found that an excellent polymer with less coloring can be produced with generating less deposition, when both the stirring device and the extrusion device were provided.

### Example 14

A polymer product of Example 14 was obtained in the same manner as in Example 6, provided that the inlet 13 b was connected to Device B instead of Device A. The properties of the obtained polymer product were measured in the aforementioned manners. The results are presented in Table 4.

### Example 15

A polymer product of Example 15 was obtained in the same manner as in Example 6, provided that carbonic acid gas (carbon dioxide), whose pressure had been increased to 15 MPa, was supplied by connecting a tank 27, which was identical to the tank 7, and a pump 28, which was identical to the measuring pump 8, to Device P with pipes. The properties of the obtained polymer product were measured in the aforementioned manners. The results are presented in Table 6.

### Example 16

A polymer product of Example 16 was obtained in the same manner as in Example 6, provided that carbonic acid gas (carbon dioxide), whose pressure had been increased to 15 MPa, was supplied by connecting a tank 27, which was identical to the tank 7, and a pump 28, which was identical to the measuring pump 8, to Device C with pipes. The properties of the obtained polymer product were measured in the aforementioned manners. The results are presented in Table 6.

### Example 17

A polymer product of Example 17 was obtained in the same manner as in Example 13, provided that carbonic acid gas (carbon dioxide), whose pressure had been increased to 15 MPa, was supplied by connecting a tank 27, which was identical to the tank 7, and a pump 28, which was identical to the measuring pump 8, to Device D with pipes. The properties of the obtained polymer product were measured in the aforementioned manners. The results are presented in Table 6.

### Example 18

A polymer product of Example 18 was obtained in the same manner as in Example 13, provided that carbonic acid gas (carbon dioxide), whose pressure had been increased to 15 MPa, was supplied by connecting a tank 27, which was identical to the tank 7, and a pump 28, which was identical to the measuring pump 8, to Device E with pipes. The properties of the obtained polymer product were measured in the aforementioned manners. The results are presented in Table 6.

### Example 19

A polymer product of Example 19 was obtained in the same manner as in Example 13, provided that carbonic acid gas (carbon dioxide), whose pressure had been increased to 15 MPa, was supplied by connecting a tank 27, which was identical to the tank 7, and a pump 28, which was identical to the measuring pump 8, to an area after (downstream of) Device E with pipes. The properties of the obtained polymer product were measured in the aforementioned manners. The results are presented in Table 6.

### Example 201

A polymer product of Example 20 was obtained in the same manner as in Example 13, provided that carbonic acid gas (carbon dioxide), whose pressure had been increased to 15 MPa, was supplied by connecting a tank 27, which was identical to the tank 7, and a pump 28, which was identical to the measuring pump 8, to both Device B and Device C with pipes. The properties of the obtained polymer product were measured in the aforementioned manners. The results are presented in Table 6.

### Example 21

A polymer product of Example 21 was obtained in the same manner as in Example 13, provided that carbonic acid gas (carbon dioxide), whose pressure had been increased to 15 MPa, was supplied by connecting a tank 27, which was identical to the tank 7, and a pump 28, which was identical to the measuring pump 8, to Device B, Device C, and Device D. The properties of the obtained polymer product were measured in the aforementioned manners. The results are presented in Table 6.

TABLE 3

| | Ex. 1 | Ex. 2 | Ex. 3 | Ex. 4 | Ex. 5 | Ex. 6 | Ex. 7 |
|---|---|---|---|---|---|---|---|
| Monomer | lactide | lactide | lactide | lactide | lactide | lactide | lactide |
| Amount of | 0.5 | 0.5 | 0.5 | 0.5 | 0.5 | 0.5 | 0.5 |
| initiator | | | | | | | |
| (mol %) | | | | | | | |
| Catalyst | DBU | DBU | DBU | DBU | DBU | DBU | DBU |
| Reaction | 100 | 100 | 100 | 100 | 100 | 100 | 100 |
| temperature | | | | | | | |
| (° C.) | | | | | | | |
| Reaction | 15 | 15 | 15 | 15 | 15 | 15 | 15 |
| pressure | | | | | | | |
| (MPa) | | | | | | | |
| Average | 60 | 60 | 60 | 60 | 60 | 60 | 60 |
| reaction | | | | | | | |
| retention time | | | | | | | |
| (min) | | | | | | | |
| Mn | 20,000 | 21,000 | 20,000 | 20,000 | 19,000 | 21,000 | 22,000 |
| Molecular | 1.7 | 1.6 | 1.7 | 1.7 | 1.8 | 1.6 | 1.5 |
| weight | | | | | | | |
| distribution | | | | | | | |
| Polymerization | 99 | 99 | 99 | 99 | 98 | 100 | 100 |
| rate (mol %) | | | | | | | |
| Continuous | B | B | B | B | B | B | A |
| production | | | | | | | |
| YI value | B | B | B | B | B | A | B |
| No. of Table 1 | 1 | 2 | 3 | 4 | 5 | 6 | 7 |

TABLE 4

| | Ex. 8 | Ex. 9 | Ex. 10 | Ex. 11 | Ex. 12 | Ex. 13 | Ex. 14 |
|---|---|---|---|---|---|---|---|
| Monomer | lactide | lactide | lactide | lactide | lactide | lactide | lactide |
| Amount of | 0.5 | 0.5 | 0.5 | 0.5 | 0.5 | 0.5 | 0.5 |
| initiator | | | | | | | |
| (mol %) | | | | | | | |
| Catalyst | DBU | DBU | DBU | DBU | DBU | DBU | DBU |
| Reaction | 100 | 100 | 100 | 100 | 100 | 100 | 100 |
| temperature | | | | | | | |
| (° C.) | | | | | | | |
| Reaction | 15 | 15 | 15 | 15 | 15 | 15 | 15 |
| pressure | | | | | | | |
| (MPa) | | | | | | | |
| Average | 60 | 60 | 60 | 60 | 60 | 60 | 60 |
| reaction | | | | | | | |
| retention time | | | | | | | |
| (min) | | | | | | | |
| Mn | 21,000 | 20,000 | 19,000 | 23,000 | 24,000 | 23,000 | 20,000 |
| Molecular | 1.6 | 1.7 | 1.8 | 1.4 | 1.4 | 1.4 | 1.6 |
| weight | | | | | | | |
| distribution | | | | | | | |
| Polymerization | 100 | 99 | 99 | 100 | 100 | 100 | 100 |
| rate (mol %) | | | | | | | |
| Continuous | B | B | B | A | A | A | B |
| production | | | | | | | |
| YI value | A | B | B | A | B | B | A |
| No. of Table 1 | 8 | 9 | 10 | 11 | 12 | 13 | — |

TABLE 5

| | Ref. Ex. 1 | Ref. Ex. 2 | Ref. Ex. 3 |
|---|---|---|---|
| Monomer | lactide | lactide | lactide |
| Amount of initiator (mol %) | 0.5 | 0.5 | 0.5 |
| Catalyst | DBU | DBU | DBU |
| Reaction temperature (° C.) | 100 | 100 | 100 |
| Reaction pressure (MPa) | 15 | 10-20 | 10-20 |
| Average reaction retention time (min) | 60 | 50-70 | 50-70 |
| Mn | — | 10,000 | 13,000 |
| Molecular weight distribution | — | 2.5 | 2.6 |
| Polymerization rate (mol %) | — | 85 | 90 |
| Continuous production | — | C | C |
| YI value | — | C | C |

TABLE 6

| | Ex. 15 | Ex. 16 | Ex. 17 | Ex. 18 | Ex. 19 | Ex. 20 | Ex. 21 |
|---|---|---|---|---|---|---|---|
| Monomer | lactide | lactide | lactide | lactide | lactide | lactide | lactide |
| Amount of | 0.5 | 0.5 | 0.5 | 0.5 | 0.5 | 0.5 | 0.5 |
| initiator | | | | | | | |
| (mol %) | | | | | | | |
| Catalyst | DBU | DBU | DBU | DBU | DBU | DBU | DBU |
| Reaction | 100 | 100 | 100 | 100 | 100 | 100 | 100 |
| temperature | | | | | | | |
| (° C.) | | | | | | | |
| Reaction | 15 | 15 | 15 | 15 | 15 | 15 | 15 |
| pressure | | | | | | | |
| (MPa) | | | | | | | |
| Average | 60 | 60 | 60 | 60 | 60 | 60 | 60 |
| reaction | | | | | | | |
| retention time | | | | | | | |
| (min) | | | | | | | |
| Mn | 22,000 | 21,000 | 23,000 | 24,000 | 24,000 | 24,000 | 23,000 |
| Molecular | 1.5 | 1.5 | 1.4 | 1.5 | 1.5 | 1.4 | 1.4 |
| weight | | | | | | | |
| distribution | | | | | | | |
| Polymerization | 100 | 100 | 100 | 100 | 100 | 100 | 100 |
| rate (mol %) | | | | | | | |
| Continuous | B | B | A | A | A | A | A |
| production | | | | | | | |
| YI value | A | A | B | B | B | B | B |

The embodiments of the present invention are, for example, as follows:

<1> A polymer production apparatus, containing:

a first supply unit configured to supply raw materials including a monomer;

a second supply unit configured to supply a compressive fluid;

a contact unit configured to bring the monomer into contact with the compressive fluid; and

a reaction unit configured to allow the monomer, which has been brought into contact with the compressive fluid, to react in the presence of the compressive fluid,

wherein the reaction unit contains one, or two or more extrusion devices, and one, or two or more stirring devices.

<2> The polymer production apparatus according to <1>, wherein the extrusion device is provided upstream of at least the one stirring device relative to a transportation path of the monomer or a generated polymer.
<3> The polymer production apparatus according to any of <1> or <2>, wherein the stirring device is at least one selected from the group consisting of a static mixer, and a driven stirring device.
<4> The polymer production apparatus according to any one of <1> to <3>, wherein the extrusion device is at least one selected from the group consisting of a pump extruder, and a mold extruder.
<5> The polymer production apparatus according to any one of <1> to <4>, further containing a third supply unit configured to supply a second compressive fluid to the reaction unit.
<6> The polymer production apparatus according to any one of <1> to <5>, further containing a discharge unit configured to discharge a polymer obtained through a polymerization reaction in the reaction unit, wherein a transportation path of the monomer or the generated polymer from the first supply unit to the discharge unit is communicated.
<7> A polymer production apparatus, containing:

a contact vessel equipped with a monomer inlet for introducing raw materials including a monomer, and a compressive fluid inlet configured to introduce a compressive fluid, where the contact vessel is configured to bring the monomer and the compressive fluid into contact with each other; and

a reaction device configured to allow the monomer, which has been brought into contact with the compressive fluid, to react through a polymerization reaction in the presence of the compressive fluid,

wherein the reaction device contains one, or two or more extrusion devices, and one, or two or more stirring devices.

### REFERENCE SIGNS LIST

1, 3, 5, 7, 11: tank
2: measuring feeder (one example of a first supply unit)
4: measuring feeder
6, 12: measuring pump
8: measuring pump (one example of a second supply unit)
9: contact unit (one example of a contact vessel)
9a: inlet (one example of a compressive fluid inlet)
9b: inlet (one example of a monomer inlet)
10: liquid feeding pump
13: reaction unit (one example of a reaction device)
13a: inlet
13b: inlet
15 extrusion cap (one example of a discharge unit)
16: pressure control valve
27: tank
28: measuring pump (one example of a third supply unit)
100: polymer production apparatus
100a: supply unit
100b: polymer production apparatus main body
P: polymer product
PP: complex product
A, B, C, D, E: extrusion device, stirring device, reaction device

1: A polymer production apparatus, comprising:
a first supply unit configured to supply raw materials comprising a monomer;
a second supply unit configured to supply a compressive fluid;
a contact unit configured to bring the monomer into contact with the compressive fluid; and
a reaction unit configured to allow the monomer, which has been brought into contact with the compressive fluid, to react in the presence of the compressive fluid,
wherein the reaction unit comprises at least one extrusion device, and at least one stirring device.

2: The polymer production apparatus according to claim 1, wherein the extrusion device is provided upstream of at least the one stirring device relative to a transportation path of the monomer or a generated polymer.

3: The polymer production apparatus according to claim 1, wherein the stirring device is at least one selected from the group consisting of a static mixer, and a driven stirring device.

4: The polymer production apparatus according to claim 1, wherein the extrusion device is at least one selected from the group consisting of a pump extruder, and a mold extruder.

5: The polymer production apparatus according to claim 1, further comprising a third supply unit configured to supply a second compressive fluid to the reaction unit.

6: The polymer production apparatus according to claim 1, further comprising a discharge unit configured to discharge a polymer obtained through a polymerization reaction in the reaction unit, wherein a transportation path of the monomer or the generated polymer from the first supply unit to the discharge unit is communicated.

7: A polymer production apparatus, comprising:
a contact vessel equipped with a monomer inlet for introducing raw materials comprising a monomer, and a compressive fluid inlet configured to introduce a compressive fluid, where the contact vessel is configured to bring the monomer and the compressive fluid into contact with each other; and
a reaction device configured to allow the monomer, which has been brought into contact with the compressive fluid, to react through a polymerization reaction in the presence of the compressive fluid,
wherein the reaction device comprises at least one extrusion device, and at least one stirring device.
